(19) United States
(12) Patent Application Publication
(10) Pub. No.: US 2025/0200623 A1
(43) Pub. Date: Jun. 19, 2025

(54) DEVICE FOR ORDERING CUSTOMIZED INGREDIENTS AND RECIPES

(71) Applicants: Sachin CHANDAK, Pune (IN); Rajeshwari Sachin CHANDAK, Pune (IN)

(72) Inventors: Sachin CHANDAK, Pune (IN); Rajeshwari Sachin CHANDAK, Pune (IN)

(21) Appl. No.: 18/852,808

(22) PCT Filed: Mar. 31, 2023
(86) PCT No.: PCT/IN2023/050321

§ 371 Date: Sep. 30, 2024

(30) Foreign Application Priority Data
Apr. 1, 2022 (IN) 202121062129

(51) Int. Cl. G06Q 30/0601; G06Q 10/0833

(52) U.S. Cl. CPC G06Q 30/0621; G06Q 10/0833

(57) ABSTRACT

In connection with a device for ordering customized ingredients and recipes from a particular second user is disclosed, a plurality of users access the device to order the ingredients to make a recipe authenticated by the second user. The first users order authentic ingredients native to region from the device for making a cuisine. The second users posts videos and details of recipe on the device. The training module in the device allows the users to be trained under guidance of registered second users. The users get recommendations of the recipes posted from the subscribed second users.

### FIELD OF THE INVENTION

The present invention relates to customised food ordering device and more particularly relates to device for ordering authentic native ingredients or dishes.

### BACKGROUND OF THE INVENTION

Online food ordering is the process of ordering food from a website or other application. The product can be either ready-to-eat food or food that has not been specially prepared for direction consumption. Ordering systems have made our lives easier especially for those who find it difficult to dine in a particular restaurant. Online ordering systems allows flexibility from ordering food, groceries, products from nearby areas to your doorsteps. Ordering systems save user's time and efforts to take away the required product, item, food from a particular place. Recent searches have revealed that at least one out of four people order food online through ordering systems.

In the art, there are many systems that allow users to order dish of their choice from variety of restaurants. However, there seem to be very efforts for ordering ingredients for making a recipe. Further, in the prior art there have been very few efforts of ordering authentic ingredients. But, the prior art does not disclose systems that facilitates ordering of exact quantity of ingredients for making a particular recipes. There have been efforts in the prior art for above mentioned problems that are discussed hereinafter.

U.S. Patent Application 2017262915A1 to Sanders Christine M teaches a food delivery system which delivers customized food product specified by the recipe input or selected from a list of recipes through a computer interface. The prepared food is delivered to the customer with label specifying the ingredients.

U.S. Patent Application 2017262915A1 to NESTEC SA discloses a system and method of providing customized pet food product by obtaining the pet profile information, comparing the pet profile information with stored nutritional information and determining and manufacturing the pet food formula.

There is a need of a device for customised ordering of authentic ingredients to make a recipe. Further there is a need of a device for providing authentic recipe to make a desired dish along with a procedure to make said dish. There is also a need of a device for ordering the authentic recipe for a predefined number of individuals.

### BRIEF DESCRIPTION OF THE DRAWINGS

The objectives and advantages of the present invention will become apparent from the following description read in accordance with the accompanying drawings wherein

FIG. 1 shows a device for ordering customised ingredients and recipes in accordance with a preferred embodiment of the present invention;

FIG. 2 shows a device architecture of the system for ordering customised ingredients and recipes of FIG. 1;

FIG. 3 shows a flow chart of a user interacting with the device for ordering customised ingredients and recipes of FIG. 1;

FIG. 4 shows a flow chart of another user interacting with the device for ordering customised ingredients and recipes of FIG. 1; and

FIGS. 5 and 6 shows a first user interface of the device for ordering customised ingredients and recipes of FIG. 1.

### SUMMARY OF THE INVENTION

A device for ordering customised ingredients and recipes including a plurality of devices for accessing the device and a warehouse storing ingredients. An interface unit configured for communicating and receiving data from the users, a processing unit communicating with the interface unit for processing data; a database communicating with the processing unit for storing data. The processing unit including an object module configured for creating a primary digital object and a secondary digital object for optimizing recipe details received from the first user and the second user and storing said objects in a memory.

A profile module being configured to edit the user profiles. A controller configured to process the data received from the interface unit and the processing unit and storing processed data into a database unit. The database unit includes a recipe repository for receiving recipe data. A primary object cycle for generating the primary object, the second user entering the recipe data for generating the primary object through the object module, and a second object cycle for generating the secondary object providing authenticity to the first users the second user. The device including a login module, an authentication module and a registration module configured for registering and authenticating a new user with the device.

The admin module being configured to provide highest level of access control of the device. The device includes an order module receiving order data from the first user. The device including a tracker module for tracking the order. The device includes a subscribe module configured to display recipes as per the user's preference. The device includes a training module configured for displaying training data. The interface unit includes a display feed displaying recipe details on respective users. The posting module receiving recipe details from the second user. The preference module being configured for receiving dietary preferences from the first user.

### DETAILED DESCRIPTION OF THE DRAWINGS

The invention herein is described using specific exemplary details for better understanding. However, the invention disclosed can be worked on by a person skilled in the art without the use of these specific details.

References in the specification to “one embodiment” or “an embodiment” means that particular feature, structure, characteristic, or function described in connection with the embodiment is included in at least one embodiment of the invention. The appearances of the phrase “in one embodiment” in various places in the specifications are not necessarily all referring to the same embodiment.

References in the specification to “preferred embodiment” means that a particular feature, structure, characteristic, or function described in detail thereby omitting known constructions and functions for clear description of the present invention.

The present invention is illustrated with reference to the accompanying drawings, throughout which reference numbers indicate corresponding parts in the various figures.

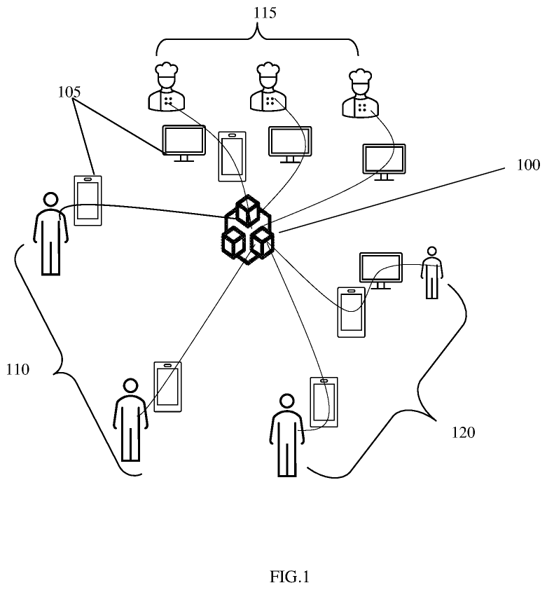

Referring to FIG. 1, a device for ordering customised ingredients and recipes 100 (hereinafter referred to as “device 100”) in accordance with a preferred embodiment of the present invention is described hereinafter. The device 100 is a platform that connects plurality of first users 110, second users 115 and the third users 120 preferably through the internet. The device 100 includes a plurality of devices 105 for accessing the device 100. In this preferred embodiment, the devices 105 are any electronic device such as handheld devices, laptops, tabs, computers and the like that have access to device 100 via Internet. However, the type of devices 105 varies in other embodiments of the present invention.

In accordance with the present invention there are at least three types of users. The first type of user (hereinafter referred to as first users) 110 are beginners, the second type of users (hereinafter referred to as second users) 115 are intermediate user, and the third type of users (hereinafter referred to as third users) 120 are advanced users. The first users 110 are for example trainees, beginners, novice and the like. The second users 115 are for example chefs, culinary experts, barista or the like. The third users 120 are for example administrators.

The second users 115 access the device 100 and creates post and authenticate recipes, evaluate the authenticity of ingredients, and posts a video of preparing the posted recipe. The first user 110 access the device 100 and learn the recipes under guidance of second users 115. The first users 110 access the device 100 to order customised ingredients and food recipes prepared or posted by the second users 115. The third users 120 monitors the operation of the device 100.

In accordance with the present invention, the first users 110 completes a specific tutorial series posted by the second users 115. Further, the second users 115, certifies the first users 110 after evaluating the progress of the first users 110 in completing video tutorials of specific pool of recipes and upgrades a particular first users 110 as a second user 115. The certified first users 110 are visible as chef and are associated with the recipe they are certified in and receive orders from the first users 110. In context of the present invention, the first users 110 upload video tutorial as per specific guideline to become a chef or the second user 115. The second users 115 authenticate the first users 110 as chef through the device 100.

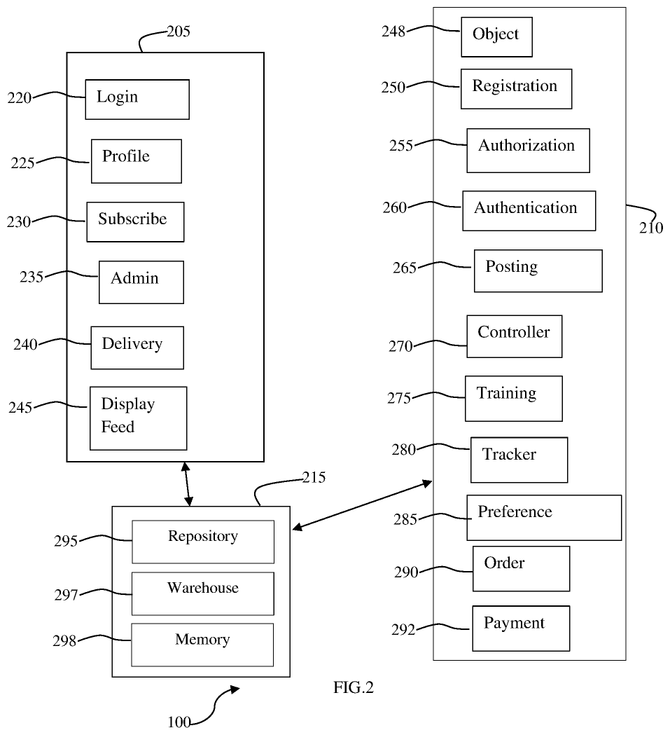

Referring to FIGS. 1 and 2, the device 100 is described hereinafter. The device 100 includes an interface unit 205, a processing unit 210 and a database unit 215. The processing unit 210 bidirectionally communicates with the interface unit 205 and the database 215. The interface unit 205 includes a login module 220, a profile module 225, a subscribe module 230, an admin module 235, a delivery module 240 and a display feed module 245. In accordance with the present invention, the interface unit 205 includes a first user interface 500, a second user interface (not seen) and a third user interface (not seen).

The first user 110 accesses the device 100 through the first user interface 500. The second user 115 accesses the device 100 through the second user interface. The third user 120 accesses the device 100 through the third user interface. In accordance with the present invention, the display feed 245 includes the first user interface 500, the second user interface and the third user interface.

Accordingly, the processing unit 210 includes an object module 248, a registration module 250, an authorization module 255, an authentication module 260, a posting module 265, a controller 270, a training module 275, a tracker 280, a preference module 285, an order module 290 and a payment module 292. The database unit 215 includes a repository 295, a memory 298 and a warehouse 297.

The interface unit 205 incudes a login module 220 that receives credentials from the registered first users 110 and validates with the data stored in the database 215. The login module 220 allows the registered first users 110 to log in to the device 100. The registration module 250, registers new first users 110, second users 115 and third users 120 with the device 100. The registration module 250 includes a registration parameter based on which the first users 110, second users 115 and the third users 120 are registered in the device 100.

The registration parameters include the details for example “name, age, gender, location of device, email id, mobile number”. The registration module 250 stores the data received from the first users 110, and the second users 115 in the database 215. In accordance with the present invention, the first users 110, second users 115 may log in with device 100 through their social media account or their existing email IDs. In the present invention, the first users 110, second users 115 resets the forgotten password by receiving new password on the registered email ID or mobile number, message verification, telephonic verification, or the like.

The authentication module 260, authenticates the registered first users 110, second users 115 and the third users 120 in the device 100. The authentication module 260 communicates with the controller 270 and accesses the registered user data and accordingly authenticates the first users 110, second users 115 and third users 120 in the device 100. The device 100, prompts the users 110, 115, 120 after logging in to the device 100, to enable their device location for ensuring delivery of ordered ingredients or dishes and checks availability of personal for delivering contents to specified location.

The admin module 235 is configured to provide highest level of access control of the device 100 to the third user 120. In the admin module 235, the third users 120 access the control parameters of the device 100 through the third user interface. In context of the present invention, the control parameters provide access to data for example “number of orders processed, amount of food items delivered in a particular month, food items that were most, access to all the orders placed in a particular time, access to statistical data of the device 100 and the like.” In accordance with the present invention, the admin module 235 is also configured to provide the administrators to view, delete, update and create a new order for ingredients, dish through the order module 290.

It is to be noted that, the first users 110, the second users 115 and the third users 120, access the profile module 225 displayed on the display feed 245 of the electronic devices 105. The first users 110, the second users 115 and the third users 120 access the profile module 225 to update, edit and add their personal details for example “to update the profile, to add payment details, to edit the addresses, check wallet balances or the like”. The device 100 displays a menu screen on respective display feeds 245 of the electronic devices 105.

The object module 248 of the device 100 includes a primary digital object 249 (not seen) and a secondary digital object 249a (not seen). The primary digital objects 249 are created by the device 100 with the inputs from the second users 115. The secondary digital objects 249a are generated by the device 100 by considering the primary objects 249 and adding a plurality of parameters to the respective primary object 249.

In accordance with the present invention, an object is created by either a first user or a second user or both. When, any user generates an order for an item of his wish, the item is created in accordance with the respective object recorded in the memory. The device may include such objects that may be in number of millions or even more than that. There is no limit of the objects created by the users.

The second type of user 115 provides inputs to the device 100 for generating the primary digital objects 249. The primary digital objects 249 include text, audio, video or a composite of said data. The primary digital object 249 includes parameters such as name, ingredients, proportions, quantity, time, energy, instructions and the like. The primary digital objects 249 are stored in the memory 298 of the device 100. The primary digital objects 249 are created by the second users 115 and are provided as inputs to the order module 290. The primary digital objects 249 are accessible from memory 298 through a database 215 of digital objects. The primary digital objects 249 of the object module 248 are selectively accessible by all types of users 110, 115 and 120 of the device 100. The users 110, 115 and 120 access the digital objects through their own devices 105 or by directly accessing the device 100.

In accordance with the present invention, once a primary digital object 249 is created by the second user 115, that respective object is accessible by the first user 110. The device 100 allows the first user 110 to generate another digital object that is a clone of the respective primary digital object 249 generated by the second user 115. The first user 110 generates an independent clone object based on the primary digital object that is, hereinafter referred as clone digital object (CDO) or secondary digital object 249a. The secondary digital object 249a includes parameter same as that of the primary digital object 249 along with some additional parameters. It is understood however that, the clone digital object 249a generated by the first user 110 is generated only if the respective primary digital object 249 has already been created by the second user 115.

According to the present invention, the clone digital object 249a is subject to approval from the secondary user 115. The clone digital object 249a receives status of approved clone digital object (ACDO) from the secondary user 115. Now, the approved clone digital object is convertible to the secondary digital object 249a with the prior consent from the third user 120. The present invention includes generation of ACDO by the first users 110 that is validated by a two-tier validation. In the two-tier validation the ACDO is executed by the second user 115 and the third user 120.

In context of the present invention, the first users 110, the second users 115 and the third users 120 views their past or current orders details on the display feed 245. The display feed 245 also displays the list of posts that are marked as favourites or saved by the first users 110, the second users 115 and the third users 120. The first users 110, the second users 115 and the third users 120 are also provided with a referral code for inviting other users on the platform, and benefit from the rewards upon successfully inviting another user.

The profile module 225 is configured to interact with the database 215 for CRUD (Create, Read, Update and Delete) operations through REST (Representational state transfer) APIs (Application Program Interface). The profile module 225 is triggered when the first users 110, the second user 115 and the third user 120 are created by the device 100. In context of the present invention, the profile module 225 is activated when the first users 110, the second users 115 and the third users 120 edit their own details.

The profile module 225 displays a success or fail message upon updating the details of the first users 110, the second users 115 and the third users 120. The device 100 updates the details in the database 215 and a success response is sent to the respective first users 110, the second users 115 and the third users 120. It is to be noted that, if the user update details fail, the reason for the failure will be provided to the first users 110, the second users 115 and the third users 120.

The preference module 285 is configured to receive inputs from the first users 110. The second users 115, however, needs to be in a serviceable area by distance for the user 110 to order food from them. In accordance with the present invention the second users 115, gets a list of orders by different first users 110, which they either accept or reject. It is to be noted that, in case the second users 115 rejects order then a reason is requested from that second user 115 and the order is accordingly communicated with the other second user 115. Once the second user 115 accepts an order, they will be prompted to answer if they have all the available ingredients to prepare the dish. In case they don't, the users 110 order all or uncommon ingredients.

The controller 270 is configured to communicate, receive and process data received from the registration module 250, the order module 290, the authentication module 260, the repository 295, the authorization module 255, the training module 275. The database 215 stores the data received from the controller 270. The data is preferably stored on mechanical hard drives, flash memories and the like.

The users registered as second users 115 are authorized to upload recipes or guide the first users 110 for a particular recipe. The second users 115 uploads the recipe through the posting module 265. The posting module 265 receives recipe details from the second users 115. The recipe details include details for example “recipe name, description, ingredients used, pre-requisites, special instructions, time for cooking, nutritional value, image and the like”.

The second users 115 selects the appropriate time for consuming the recipe for example, breakfast, lunch, dinner, dessert through the recipe posting module 265. The posting module 265 is configured to allow the second users 115 to preview the recipe and makes any necessary edits. The controller 270 stores the recipe data into the repository 295 along with the recipe details and details of the second users 115 posting the recipe. The recipe details are notified to the first users 110 following a particular second user 115 once the recipe is published.

The controller 270 is configured to fetch the recipe details from the repository 295 as per the first users 110 dietary preference and displays the dishes on the display feed 245. The display feed 245, displays all the recipe details that are marked as favourites by the first users 110 and the second users 115. The first users 110 places the orders of the recipes through the display feed 245.

The order module 290, receives order data from the first users 110. In this preferred embodiment, the order data includes the type of dish the user has ordered, ingredients the user needs to prepare the dish, quantity of ingredients, prepared by a particular chef and the like. However, the order data varies in other embodiments of the present invention. The device 100 checks with the second users 115 and the warehouse 297 for available data.

In context of the present invention, the first users 110, the second users 120 selects to order the ingredients. Further, the list of ingredients is displayed and gets the flexibility to order all the ingredients or just the uncommon ones. The dish or the ingredients are added to the checkout cart such that the first users 110 reviews and places the final order. The first users 110 are directed towards the payment module 292 that accepts the payment details from the particular first users 110 and responds accordingly with the controller 270. The controller 270 then displays a success message or failure message as per the status of the payment.

The tracker 280, facilitates the first users 110 to track the status of the order placed to the device 100. The tracker 280, communicates the estimated delivery time to the first users 110 through devices 105. The training module 275 is configured to receive video tutorial from the second users 115 to post their tips, recipes in a particular group or playlist. In context of the present invention, the second users 115 creates a tutorial with his varied range of recipes, cooking tips, own secrets, or the like in a playlist to avail the first users 110. The second users 115 may have multiple playlists with each playlist containing different types of videos.

The repository 295, receives recipe data from the registered second users 115. In this preferred embodiment, the recipe data includes quantity of ingredients, special ingredients, type of ingredients, step wise method of preparing, time of preparing, authenticity of ingredients, a video or audio file of making recipe, details of second users 115 posting the recipe, and the like for preparing a particular cuisine. However, the type of recipe data varies in other embodiments of the present invention.

The warehouse 297, stores the required food material, ingredients for preparing cuisines. The controller 270 stores the data of available food materials in the warehouse 297 in the database 215. The authorization module 255, checks for available ingredients for preparing ordered recipe in the warehouse 297 by communicating with the database 215 through controller 270. The authorization module 255, instructs to transfer the required food material for preparation of dish from the warehouse to a desired location.

The delivery module 240 estimates the approximate time required to deliver the food ingredients from warehouse 297 to second users 115 or to the required kitchen. The first users 110 subscribe to the recipes posted by a particular second user 115. The subscribe module 230, shows the posts posted by a particular chef and recommends the recipes posted by that chef.

In this preferred embodiment, the display data includes status of the order, available recipes, ingredients, information of second users 115 and the like. However, the display data varies in other embodiments of the present invention. The display feed 245 communicates with the controller 270 to display information on the devices 105. The controller 270 is configured to communicate the different modules of the device 100 with one another.

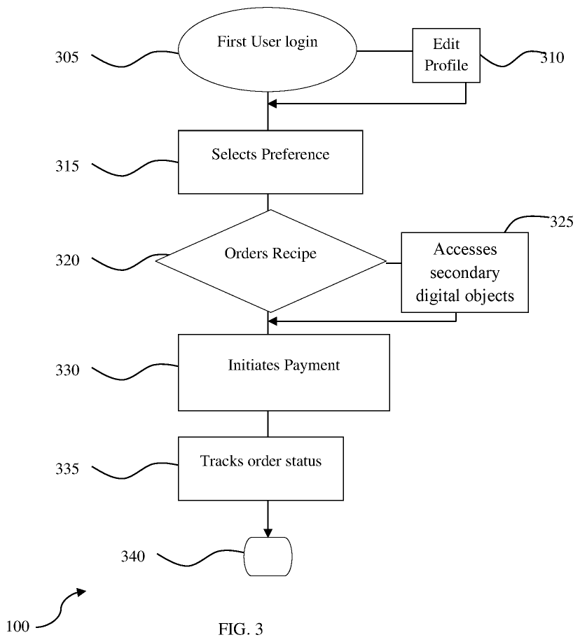

Referring to FIGS. 1 to 3, a process of ordering an item based on the primary object 249 generated by the secondary user 115 using the device 100 is described. In an initial step 305, the registered first users 110 logs in using their social media account or their email IDs. In this step 305, the new first users 110 not registered with the device 100 registers with the device 100 by entering their credentials and registering with the device 100 through the registration module 250. In this step 305, the first users 110 credentials are validated by the authentication module 260 and accordingly the first users 110 log in to the device 100.

In a next step 310, the first users 110 may update their personal details through the profile module 225 and accordingly the controller 270 stores the updated data in the database 215. In this step 310, the first users 110 are prompted to enable the device 105 location after logging in to the device 100. In a next step 315, the first users 110 select their dietary preferences and provides diet parameters to the device 100. In this step 320, the first users 110 receives food suggestions according to the diet preferences, specific content, recipes posted by other members of the group, dynamically acting as social media for food. In this step 320, the first users 110 interact with the posts by engaging in comments, appreciation, or the like. In this step 320, the first users 110 order a recipe or its ingredients through the posts.

In a next step 325, the first users 110 select to cook recipes posted on the display feed 245 and are directed to a cooking tutorial page through the training module 275. In this step 325, the first users 110 receive step-by-step instructions to cook that recipe until they finish cooking. Further, the first users 110 also provide feedback, suggestions, and reviews after cooking the recipe on their own. In a next step 330, the first users 110 may select to order the primary object 249 that has for example, recipe ingredients of a food item for which the object is created. In this step 320, the users may also select the second users 120 to order the primary object 249 that includes for example ingredients of the item.

In this step 330, the first users 110 also select and check out details such as the item price, and distance, and choose a time slot and day for the delivery. In this step 330, the first users 110 provide order details. In this step 330, the first users 110 may choose to order the ingredients instead such that they will be shown the list of ingredients and get the flexibility to order all the ingredients or just the uncommon ones. In this step 330, a summarized list of the final order is displayed with the equivalent price. In a next step 335, the first users 110 select the delivery date and proceed to checkout by completing the payment order through the payment module 292.

In this step 335, the first users 110 track/refer the orders as per requirement. In this step 335, the tracker module 280 displays a tracking page with the latest update on the first users 110 package, and a support button is also provided to open a support ticket as per first users 110 requirement. In a final step 340 the first users 110 confirms the delivered order via an OTP so that it is updated in the device 100.

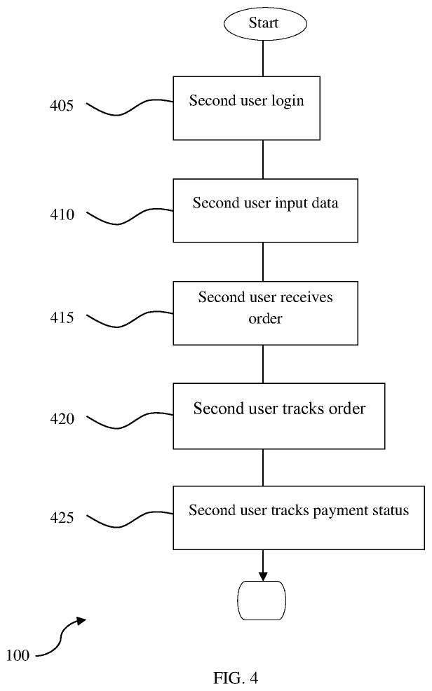

Referring to FIGS. 1 to 4, a process of posting an order of the second users 120 in accordance with the device 100 is described. In an initial step 405, the second users 120 logs in to the device 100 through the login module 220. In a next step 410, the second users 120 uploads the tutorials of a particular recipe or a playlist of preparing a dish along with the detailed instructions. In a next step 420, the second users 120 receives orders from the first users 110 for preparing a particular recipe. In this step 420, the second users 120 confirm the order of a particular details upon analysing the order details and delivery details and accordingly sends response to the order.

In accordance with the present invention, if the second user 120 rejects an order, then a reason is required to be provided and accordingly the order is communicated with the next second user 120 registered into the device 100. In a next step 420, if the second users 120 accepts a particular order. In a next step 425, the second users 120 provides the ingredients or the dish requested by a particular first users 110 and tracks the status of order delivered to the first users 110 through the tracker module 280.

Now referring to FIGS. 1 to 4, a process of creating a primary object cycle by the second user 115 is described. In an initial step, the second users 115 accesses the device 100 through the login module 220. In a next step, the second user 115 submits the recipe data for example audio instructions, video tutorials, text details and the like through the posting module 265. In a next step, the recipe data is received by the processing unit 210. In a next step, the processing unit 210 commands the controller 270 to invoke object module 248 for creating the primary digital object 249.

The object module 248 wraps the recipe data of the primary digital object 249 in a single object file in other words, the object file is composite of plurality of primary digital objects 249. The object file of the second user 115 is stored in the memory 298 of the database unit 215. It is to be noted that, the object module 248 is configured for creating multiple object file for multiple second users 115 and storing said object filed respectively in the memory 298.

Referring to FIGS. 1 to 4, a process of creating a secondary object cycle by the first user 110 is described. Initially, the registered first user 110 logs in to the device 105 through login module 220. The first users 110 checks for the recipe's posted by the second user 115. In a next step, the first user 110 provides recipe data to the device 100 for cloning a primary digital object 249. In a next step, the second user 115 and the third user 120 assesses the recipe data received from the first user 105. In a next step, as per the instructions received from the users 115 and 120 the processing unit 210 notifies the object module 249 to create a clone object. In accordance with the present invention, the clone object is preferably the secondary object 249a of the primary object 249. Further, the processing unit 210 invokes the object module 248 to clone the existing primary object 249.

In a next step, the object module 248 creates the secondary digital object 249a by fetching details of the primary object 249 and creating similar object file as per the details entered by the first user 110. In accordance with the present invention, the primary object cycle and a secondary object cycle authenticate the primary object 249 and the secondary object 249a with the device 100.

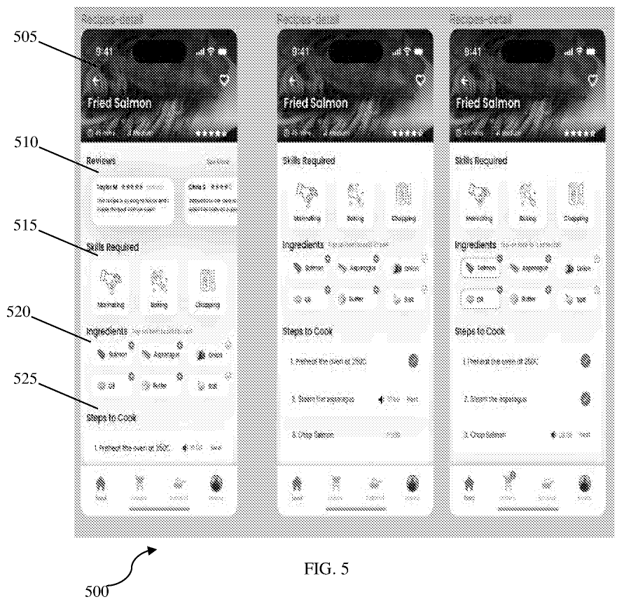

Now referring to FIG. 5, the first user interface 500 in accordance with the device 100 is described. The first user 110 accesses the device 100 through the devices 105. The first user interface 500 is preferably displayed on the display feed 245 of the registered first user 110. The display feed 245 of the first user interface includes a first panel 505. The first panel 505 and a second panel 510 further includes the recipe details for example, name of the recipe to be prepared, time for preparing that recipe, the ratings received from other users for that recipe and the like. The display feed 245 includes a third panel 515. The third panel 515 includes specific skill set required for preparing a recipe for example, marinating, baking, chopping, topping and the like.

The display feed 245 includes a fourth panel 520 also. The fourth panel 520 includes the ingredients that are required to prepare a specific recipe for example fruits, vegetables, seasonings, spices, dairy products and the like. The display feed 245 includes a fifth panel 525 that includes steps for preparing a specific recipe. For example, preheating, steaming, chopping contents and the like. It is to be noted that the display feed 245 displays said panels 505, 510, 515, 520 and 525 after placing an order by the first user 110 to the device 100. Accordingly, the display panels 505, 510, 515, 520 and 525 optimizes the first user 110 to prepare a recipe based on the data displayed on said panels.

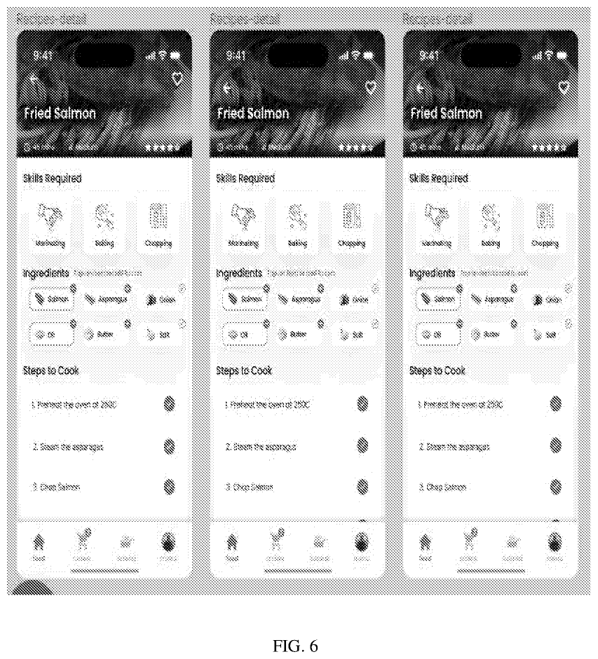

Referring to FIGS. 1 to 6, an operational flow of the device 100 is described hereinafter. In operation, the first users 110, second users 115 and the third users 120 accesses the device 100 through the devices 105. The first users 110, the second users 115 and the third users 120 registers with the device 100 through the registration module 250. The registered first users 110, the second users 115 and the third users 120 are authenticated in the device 100 through the authentication module 260.

The second users 115 posts the recipe details through the second user interface and is received by the posting module 265. The posting module 265 receives the recipe data from the second users 115 and saves the data in the recipe repository 295. Inside the database 215. The display feed 245 access the recipe data from the database 215 and displays on the devices 105.

The registered first users 110 orders the recipes. Accordingly, the first user 110 accesses the first user interface 500 i.e., the display feed 245. The first user 110 selects recipe or ingredients that is displayed on the display feed 245. Further, the selected recipe or ingredients are placed through the order module 290. The order module 290 receives the order from the first users 110 in the form of order data. This order data is stored in the database 215 through the controller 270. A summarized list of the final order is displayed with the pricing. Further, the user selects the delivery date and proceed to checkout.

The checkout page is similar for both recipe and ingredient orders, with a section to apply available coupons, show the final price and summary, and choose a payment mode. Once the payment is successful, the user is taken to the order. The authorization module 255, analyses the ingredients required for ordered recipe by accessing the order data. Further, the authorization module 255 access the data related to available food materials in the warehouse 297 through the controller 270.

Further, the authorization module 255 checks for the availability of ingredients required for the ordered recipe from the warehouse 297. The authorization module 255, then orders the required ingredients and food materials from warehouse 297 to the second users 115 location through the delivery module 240. The second users 115 authenticates the food materials and ingredients to be delivered to the first users 110 through the delivery module 240. The subscribe module 230, allows the first users 110 to subscribe to the videos posted by a particular second users 115.

The tracker module 280 tracks the delivery of ordered food from the first users 110 and displays the status of the ordered food on the display feed 245. The training module 275, allows the trainees 120 to learn the recipes from the registered second users 115. Once the order is delivered, the user confirms via an OTP so that it is updated in the device 100. The training module 275, allows the trainees 120 to also post their recipes and store the same in the database 215.

The device 100 advantageously, allows the users to order authentic ingredients for an authentic recipe posted by authenticated second users. The device 100 advantageously, allows trainees and users to prepare the recipe for the ordered ingredients under guidance of registered second users 120. The device 100 advantageously, provides appropriate amount and quantity of ingredients for preparing a specific cuisine.

The foregoing description of specific embodiments of the present invention has been presented for purposes of illustration and description. They are not intended to be exhaustive or to limit the present invention to the precise forms disclosed, and obviously many modifications and variations are possible in light of the above teaching.

The embodiments were chosen and described in order to best explain the principles of the present invention and its practical application, to thereby enable others, skilled in the art to best utilize the present invention and various embodiments with various modifications as are suited to the particular use contemplated.

It is understood that various omission and substitutions of equivalents are contemplated as circumstance may suggest or render expedient, but such are intended to cover the application or implementation without departing from the scope of the present invention.

1. A device for ordering customized ingredients and recipes including a plurality of devices for accessing the device and a warehouse storing ingredients, the device comprising:
an interface unit configured for communicating and receiving data from the users and, a processing unit communicating with the interface unit for processing data;
a database communicating with the processing unit for storing data;
the processing unit including an object module configured for creating a primary digital object and a secondary digital object for optimizing recipe details received from the first user and the second user; and storing said objects in a memory; a profile module being configured to edit the user profiles;
a controller configured to process the data received from the interface unit and the processing unit and storing processed data into a database unit; the database unit includes a recipe repository for receiving recipe data; and
a primary object cycle for generating the primary object, the second user entering the recipe data for generating the primary object through the object module, and a second object cycle for generating the secondary object providing authenticity to the first users; the second user.

2. The device for ordering customized ingredients and recipes as claimed in claim 1, wherein the device includes:
a login module,
an authentication module and
a registration module configured for registering and authenticating a new user with the device.

3. The device for ordering customized ingredients and recipes as claimed in claim 1, wherein the admin module is configured to provide highest level of access control of the device.

4. The device for ordering customized ingredients and recipes as claimed in claim 1, wherein the device includes an order module receiving order data from the first user.

5. The device for ordering customized ingredients and recipes as claimed in claim 1, wherein the device includes a tracker module for tracking the order.

6. The device for ordering customized ingredients and recipes as claimed in claim 1, wherein the device includes a subscribe module configured to display recipes as per the users preference.

7. The device for ordering customized ingredients and recipes as claimed in claim 1, wherein the device includes a training module configured for displaying training data.

8. The device for ordering customized ingredients and recipes as claimed in claim 1, wherein the interface unit includes a display feed displaying recipe details on respective users.

9. The device for ordering customized ingredients and recipes as claimed in claim 1, wherein a posting module receives receiving recipe details from the second user.

10. The device for ordering customized ingredients and recipes as claimed in claim 1, wherein a preference module is configured for receiving dietary preferences from the first user.
